(19) United States
(12) Patent Application Publication
(10) Pub. No.: US 2009/0263003 A1
(43) Pub. Date: Oct. 22, 2009

(54) Method for investigating digital images for cancer based on parameters using samples in images

(76) Inventors: George Madathilparambil George, Mumbai (IN); Sanjeev Saxena, Mumbai (IN)

Correspondence Address: George Madathilparambil George, 201, Vedanta Bldg., 779 Makhwana Rd, Andheri, Mumbai, 400059, IN

(21) Appl. No.: 12/386,840

(22) Filed: Apr. 24, 2009

(51) Int. Cl. G06K 9/00

(52) U.S. Cl. 382/133

(57) ABSTRACT

A method for dividing value space of parameters into ranges using samples wherein these ranges are used for detection of cancer in a region or segment in a digital image. A method for assisting the investigation in detection of cancer in a region in a first digital image of a human body or a human body part using ranges of parameters computed using samples. A method for performing medical diagnostics for detection of cancer over a computer network.

### BACKGROUND OF THE INVENTION

Computer Aided Diagnostics (CAD) for detecting cancer in digital images of parts of human body which are in use today, have an accuracy of less than 90%. This accuracy rate necessitates the need for a second test which causes trauma and additional costs to patients.

### BRIEF SUMMARY OF THE INVENTION

It is the object of the invention to use sample regions of digital images with known results and parameters values corresponding to those sample regions with the known results to determine ranges of parameters wherein those ranges of parameters are used for assisting the investigation in detection of cancer in a region of a digital image of a human body or a part of human body. Sample regions are also referred to as samples. A method which is implemented in a computer or in an embedded system is used to identify ranges of parameter values for each parameter using known results.

This paragraph illustrates an example of a method which is implemented in a computer or in an embedded system which is used to identify ranges of parameter values wherein these ranges of parameter values are used for detection of cancer:
(a) The parameter value space of each parameter is divided into a first set of ranges using sample regions where:
   (i) all sample regions with a parameter value within each range in that first set of ranges have the same known result;
   (ii) a minimum threshold number of sample regions have a parameter value within each range in that first set of ranges; and
   (iii) each range in that first set of ranges is as big as possible.
(b) The ranges of values of the parameter space which is not part of the first set of ranges forms a second set of ranges.
(c) The second set of ranges are divided into additional ranges if the number of sample regions in that range exceeds a maximum threshold to obtain a third set of ranges.
(d) A method is then used to change each of the ranges in the third set of ranges for each result corresponding to sample regions as follows:
   (i) a weightage is calculated for ranges wherein weightage for a result in a range is a function of or ratio between the number of samples with that result in that range and number of samples in that range;
   (ii) the weightage of all adjacent ranges are compared wherein two ranges are adjacent if the last sample region of a first range is next to the first sample region of a second range in a sorted list of sample regions which are sorted based on parameter values; and
   (iii) the adjacent range with the higher weightage is increased by decreasing the adjacent range with the lower weightage if the increased portion of that adjacent range with the higher weightage contains only sample regions with that known result and the increase in range does not cause the number of sample regions in the adjacent range with the lower weightage to fall below a threshold.
(e) Each range in the first set of ranges are divided into additional ranges if the number of sample regions in that range exceeds a maximum threshold.

A weightage function used for computing weightage for each result for each range is a function of the number of sample regions with that given result in that range and the total number of sample regions in that range. The weightage function gives a higher value if the ratio between the number of sample regions with that result in that range and total number of sample regions in that range, is higher. When the number of sample regions in a range is below a threshold a complex weightage is used for that range wherein a complex weightage is a function of the number of sample regions with that given result in that range, the total number of sample regions in that range, the number of sample regions with that given result in each adjacent range of that range, the total number of sample regions in each adjacent range in that range. An example of a complex weightage is a function simple weightage of that region and simple weightages of adjacent ranges of that range.

### BRIEF DESCRIPTION OF THE SEVERAL VIEWS OF THE DRAWING

FIG. 1 illustrates an example of an integer value space divided into 3 ranges.

FIG. 2 illustrates an example of a real value space divided into 6 ranges.

FIG. 3 illustrates an example of a function in a computer program which is used for dividing value space of a parameter into ranges so that those ranges enables good diagnosis of cancer.

FIG. 4 illustrates an example of data structures corresponding to ranges in FIG. 1.

FIG. 5 illustrates an example of a function in a computer program which is used to change the ranges of a parameter so that those ranges enables better diagnosis of cancer.

FIG. 6 illustrates an example for creating a good parameter using properties of regions of digital images.

### DETAILED DESCRIPTION OF THE INVENTION

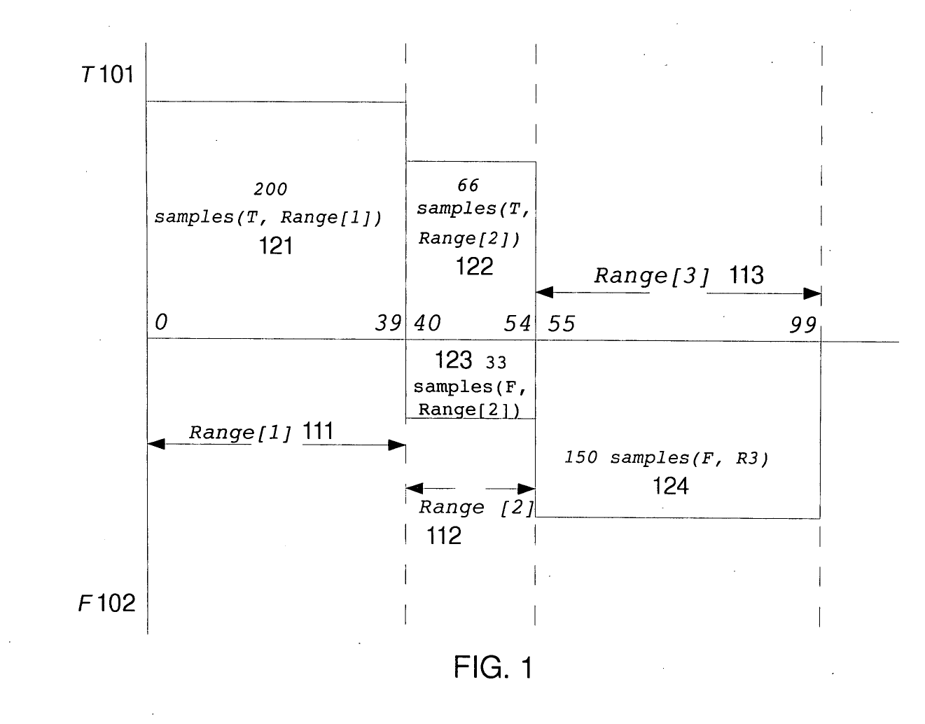

FIG. 1 illustrates the value space of an integer parameter which is divided into ranges and the result space contains 2 values T 101 and F 102. The value space is divided into 3 ranges Range[1] 111, Range[2] 112 and Range[3] 113. The range of values in the range Range[1] 111 is from 0 to 39. The range of values in the range Range[2] 112 is from 40 to 54. The range of values in the range Range[3] 113 is from 55 to 99. The range Range[1] 111 has 200 samples (sample regions) 121 which have parameter values between 0 and 39 and with the result T. The range Range[2] 112 has 66 samples (sample regions) 122 with values between 40 to 54 with the result T and 33 samples (sample regions) 123 with values between 40 to 54 and the result F. The range Range[3] 113 has 150 samples (sample regions) 124 which have parameter values between 55 to 99 and with the result F.

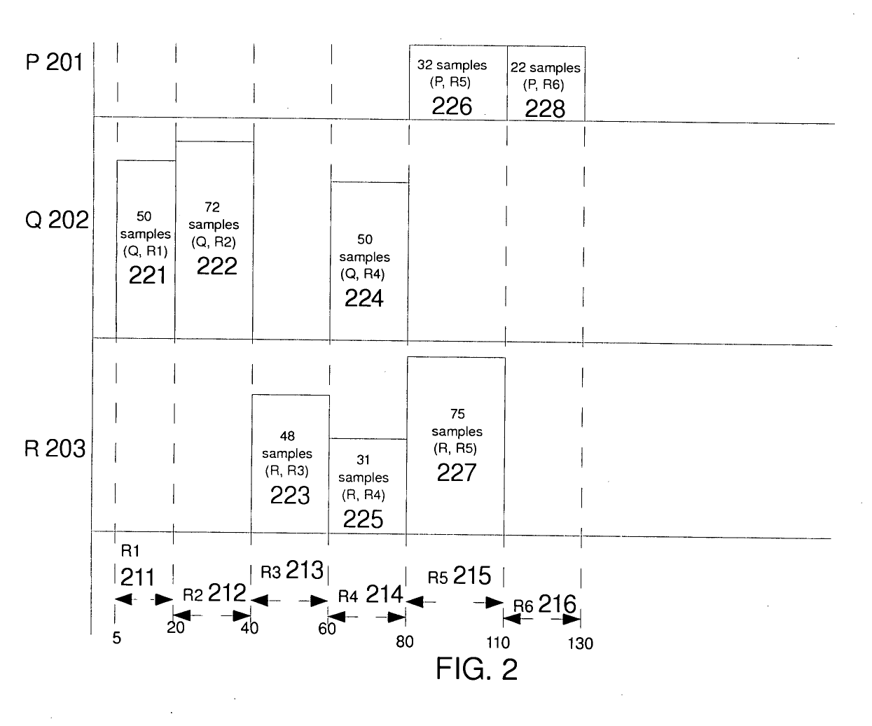

FIG. 2 illustrates the value space of a parameter which is divided into ranges and the result space contains 3 values P 201, Q 202 and R 203. The real value space is divided into 6 ranges R1 211, R2 212, R3 213, R4 214, R5 215 and R6 216. The values of parameters in this example have an accuracy of 4 decimal places. The range of values in the range R1 211 is from 5 to 19.9999. The range of values in the range R2 212 is from 20 to 39.9999. The range of values in the range R3 213 is from 40 to 59.9999. The range of values in the range R4 214 is from 60 to 79.9999. The range of values in the range R5 215 is from 80 to 109.9999. The range of values in the range R6 216 is from 110 to 129.9999. The range R1 211 has 50 samples (sample regions) 221 with the result Q which have parameter values within the range 5 to 19.9999. The range R2 212 has 72 samples (sample regions) 222 with the result Q which have parameter values within the range 20 to 39.9999. The range R3 213 has 48 samples (sample regions) 223 with the result R which have parameter values within the range 40 to 59.9999. The range R4 214 has 50 samples (sample regions) 224 with the result Q which have parameter values within the range 60 to 79.9999 and 31 samples (sample regions) 225 with result R within the range 60 to 79.9999. The range R5 215 has 32 samples (sample regions) 226 with the result P within the range 80 to 109.9999 and 75 samples (sample regions) 227 with the result R within the range 80 to 109.9999. The range R6 216 has 22 samples (sample regions) 228 with the result P within the range 110 to 129.9999.

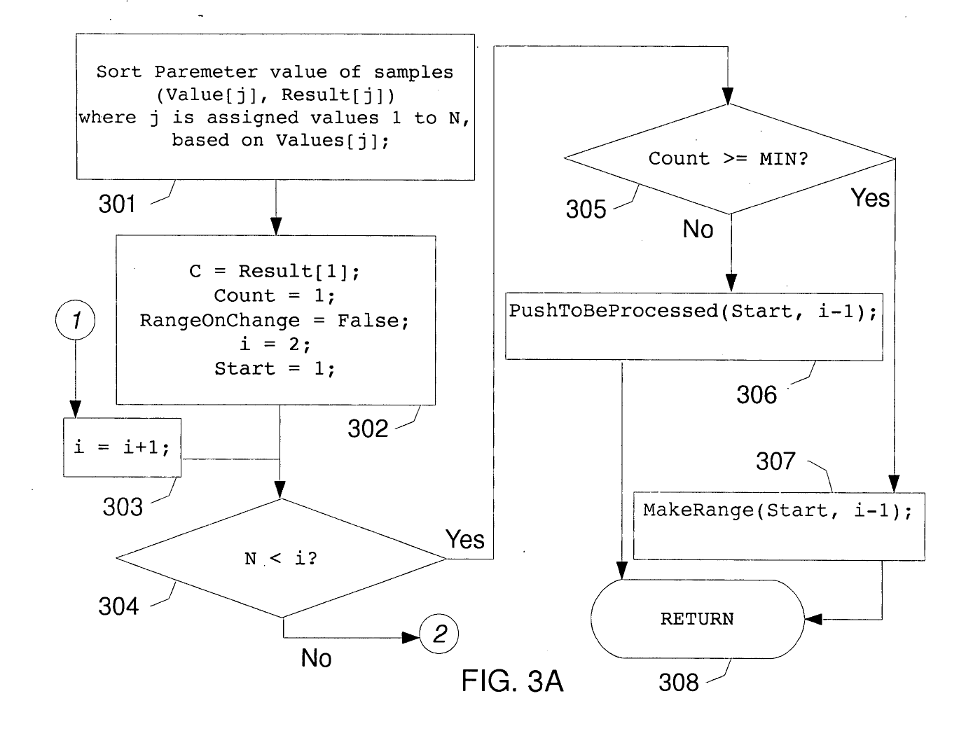

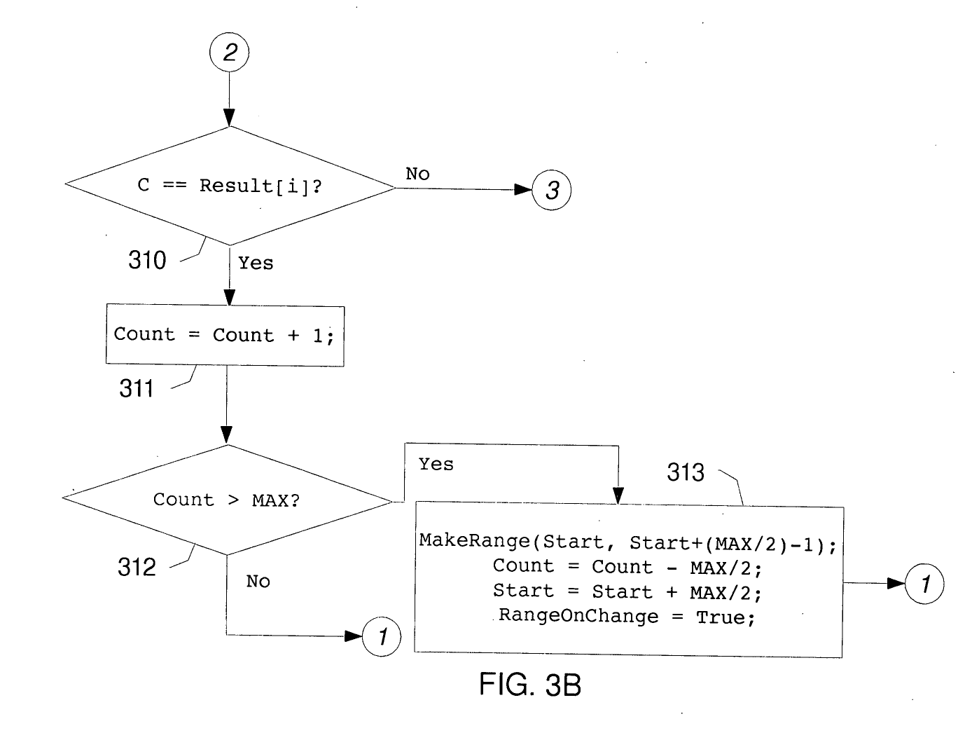

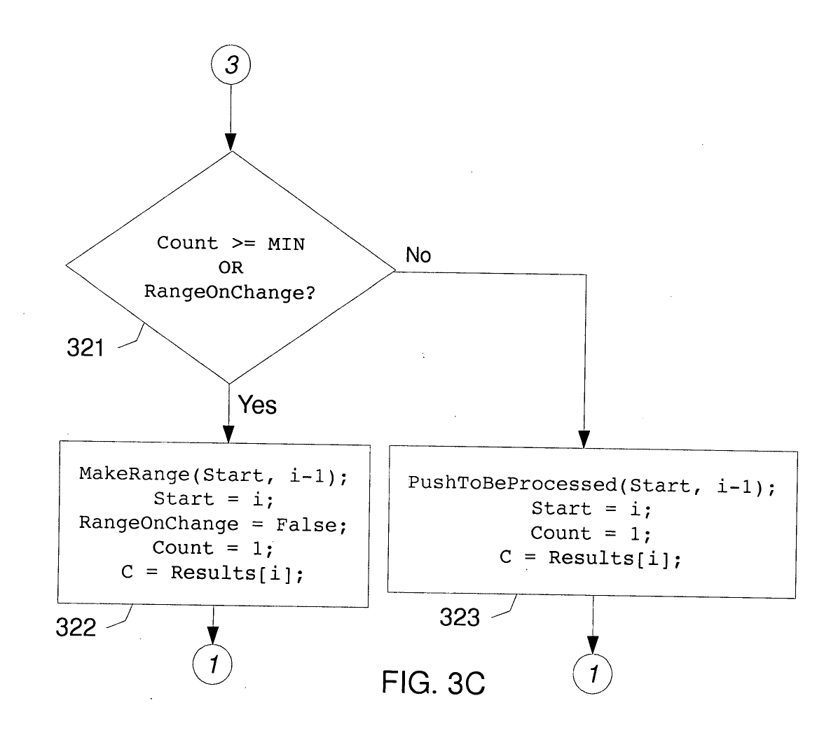

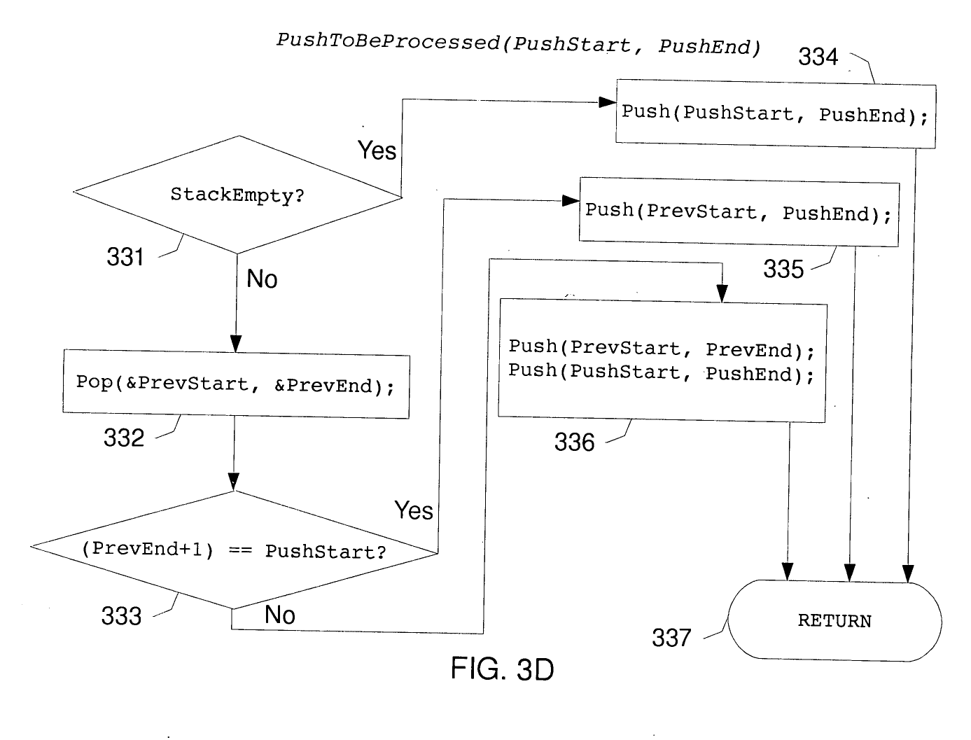

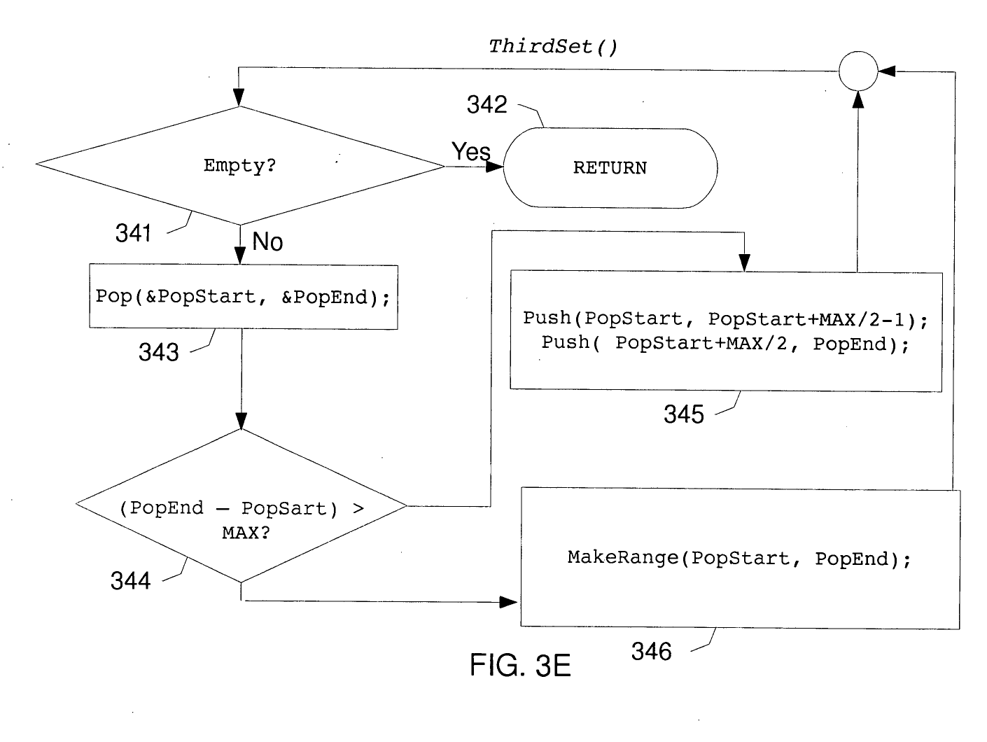

FIG. 3 illustrates an example of state machine of a high level language function in a computer program which is used for dividing value space of a parameter into ranges. The algorithm first creates a set of same result ranges wherein a same result range is a range of parameter values and all sample regions with parameter values within that same result range have the same result. In the initial state 301 in FIG. 3A, N parameter values corresponding to the sample regions are sorted to a sorted list indexed by integers 1 to N. In the loop initialization 302 state, the variable C is set to the value of the first element (indexed by 1) in the Result array (Result[1]) in the sorted list, Count is set to 1, the variable RangeOnChange is set to boolean value False, the loop count i is set to 2 and index Start is set to 1. The loop count i is incremented 303 for all subsequent iterations of the loop. Inside the loop, if the loop count i exceed the integer N 304, the function goes to a state 305 in which the variable Count is tested to check whether it has reached or exceeded the minimum threshold MIN. If the variable Count is greater than or equal to MIN the function goes to a state 307 in which a new range of values starting at index Start and ending at index i−1 is created and the function returns 308. If Count is less than the minimum threshold MIN 306, the range of values starting at index Start and ending at index i−1 are passed to a function PushToBeProcessed to be pushed to a stack for future processing and the function returns 308. If the index i is less than the integer N the function goes to a state 310 in FIG. 3B in which the variable C is compared with Result[i] wherein the loop variable i acts as the index for the array Results. If the variable C and Result[i] are the same, then the variable Count is incremented 311 and the variable Count is tested 312 to see whether it exceeded the maximum threshold MAX. If Count exceeds the maximum threshold MAX the function goes to a state 313 in which a new range is created starting at index Start and ending at index Start+(MAX/2)−1 wherein MAX/2 is the maximum threshold MAX divided by 2. In that state 313, the variable RangeOnStart is set to True, the index Start is set to the value Start+(MAX/2) and the variable Count is decremented by MAX/2. The function goes from that state 313 to the state 303 in which the next iteration of the loop is started by incrementing the loop count i. If the variable Count is less than the maximum threshold MAX, then the function goes to the state 303 in which the next iteration of the loop is started by incrementing the loop count i. If the variable C is different from Result[i] 310, the function goes to a state 321 in FIG. 3C in which the variable RangeOnChange is tested to check whether it is true and the variable Count is tested to check whether it has reached or exceeded the minimum threshold MIN. The results of these tests are OR operated 321 and if the output of the OR operation is true, the function changes to a state 322 in which a new range is created starting at the index Start and ending at the index i−1. In that state 322, the variable RangeOnStart is set to False, the index Start is set to the value of the loop count i, the variable Count is set to 1 and the variable C is set to the value of Result[i]. The function then goes from that state 313 to the state 303 in which the next iteration of the loop is started by incrementing the loop count i. If the output of the OR operation 321 is false, the function goes to a state 323 in which the range of values starting at index Start and ending at index i−1 are passed to a function PushToBeProcessed to be pushed to a stack for future processing. In that state 323, the index Start is set to the value of the loop count i, the variable Count is set to 1 and the variable C is set to the value of Result[i]. The function then goes from that state 323 to the state 303 in which the next iteration of the loop is started by incrementing the loop count i. The state diagram of the function PushToBeProcessed called with variables PushStart and PushEnd is illustrated in FIG. 3D. In the state 331, the stack empty condition is tested. If the stack is empty 334, then the variable pair PushStart and PushEnd are pushed to the stack (stack or stack pointers are not shown) and the function PushToBeProcessed returns 337. If the stack is not empty 332, a variable pair PrevStart and PrevEnd are popped from the stack and PushStart is tested for equality 333 with PrevEnd+1. If PushStart is equal to PrevEnd+1 335, the ranges are combined by pushing the variable pair PrevStart and PushEnd to the stack and the function PushToBeProcessed returns 337. If PushStart is not equal to PrevEnd+1, the function goes to a state 336 in which first the value pair PrevStart and PrevEnd are pushed back to the stack and then the value pair PushStart and PushEnd are pushed to the stack and the function PushToBeProcessed returns 337. FIG. 3E illustrates a function ThirdSet( ) is used to process variable pairs pushed to the stack. In the state 341, a test for stack empty condition is made and if the stack is empty, the function ThirdSet returns 342. If the stack is not empty 343, a pop operation on the stack is done to get the pair of variables PopStart and PopEnd and the difference between PopStart and PopEnd is compared against a maximum threshold MAX 344. If the difference between PopStart and PopEnd exceeds the maximum threshold MAX, the state machine of the function goes to a state 345 in which two push operations to the stack are done wherein the first push operation pushes the value pair PushStart and PushStart+(MAX/2)−1 and the second push operation pushes the value pair PushStart+(MAX/2) and PushEnd. Then the function then goes back to the state 341 in which a test for empty condition is done. If the difference between PopStart and PopEnd does not exceed the maximum threshold MAX, the state machine of the function goes to a state 346 in which a new range atarting at PopStart and ending at PopEnd is created and the function then goes back to the state 341 in which a test for empty condition is done.

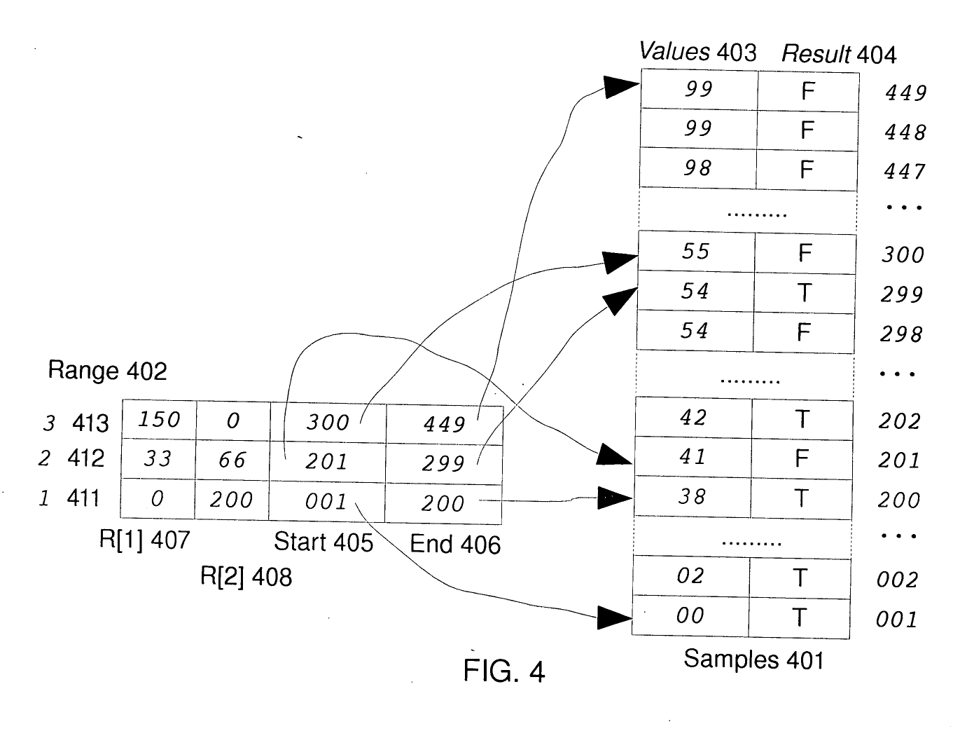

FIG. 4 illustrates an example for the datastructures created for ranges illutrated in FIG. 1 by a range finding algorithm based on the function illustrated in FIG. 3. Samples (sample regions) 401 is an array of Values (parameter values) 403 and Result 404 pairs sorted based on Values. There are three elements in the array Range 402 which are Range[1] 411, Range[2] 412 and Range[3] 413. The Start 405 index of the Range[1] 411 is 1 and End 406 index of the Range[1] 411 is 200 wherein the Start index and End index indexes into the Samples (sample regions) array 401. The Start 405 index of Range[2] 412 is 201 and End index 406 of the Range[2] 412 is 299. The Start 405 index of the Range[3] 413 is 300 and End index 406 of the Range[3] 413 is 449. Samples (sample regions) support 2 possible values for the element Result 404, a first value F and a second value T. The Result F is mapped to an index 1 and the result T is mapped to an index 2. The number 200 in array element R[2] 408 in Range[1] 411 indicates that the Range[1] 411 has 200 samples (sample regions) with the Result 404 value equal to T. The number 66 in array element R[2] 407 in Range[2] 412 indicates that Range[2] 412 has 66 samples (sample regions) with the Result 404 value equal to T. The number 33 in array element R[1] 408 in Range[2] 412 indicates that Range[2] 412 has 33 samples (sample regions) with Result 404 value equal to F. The number 150 in array element R[1] 407 in Range[3] 413 indicates that Range[3] 413 has 150 samples (sample regions) with Result 404 value equal to F. The number of samples in a range can be obtained as End-Start+1.

A example of a formula that can be used for computing simple weightage for a range for an expected result A, is W1[r]=f1(X[r], T[r]) wherein
(a) f1 is a function of T[r] and X[r];
(b) T[r] is the number of sample regions in a range r;
(c) and X[r] is the number of sample regions with a known result A in the range r.
   An example for simple weightage is W1[r]=f1(X[r], T[r])=(2X[r]−T[r])/T[r]. In this case, negative value for f1(X[r], T[r]) for a given range for a given result A in this case indicates that occurance of result A is unlikely if the parameter value corresponding to a region under diagnosis is in that range. A positive value for f1(x[r], T[r]) for a given range for a given result B in this case indicates that occurance of result B is likely if parameter value the parameter value corresponding to a region under diagnosis is in that range.

The ranges can be made more effective by changing the start and end of ranges. For a first range and a second range adjacent to each other in value space wherein that first range has a higher weightage for a given result than that second range, that first range and the second range are changed so that the number of sample regions with that result in the first range is increased and number of sample regions with a that result in the second range is accordingly decreased provided that change can be done without affecting the number of sample regions with other results in the first or the second ranges.

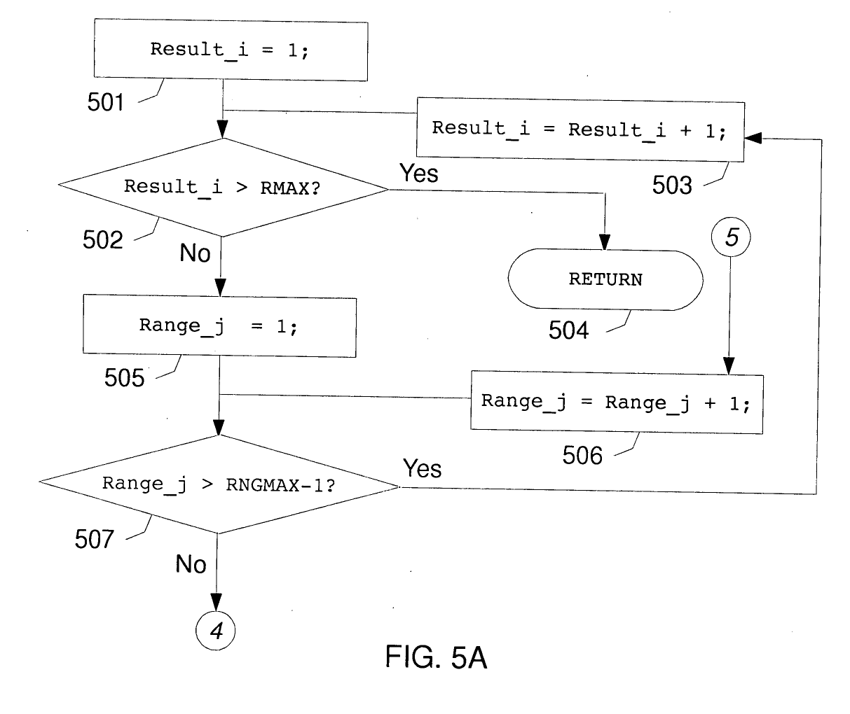

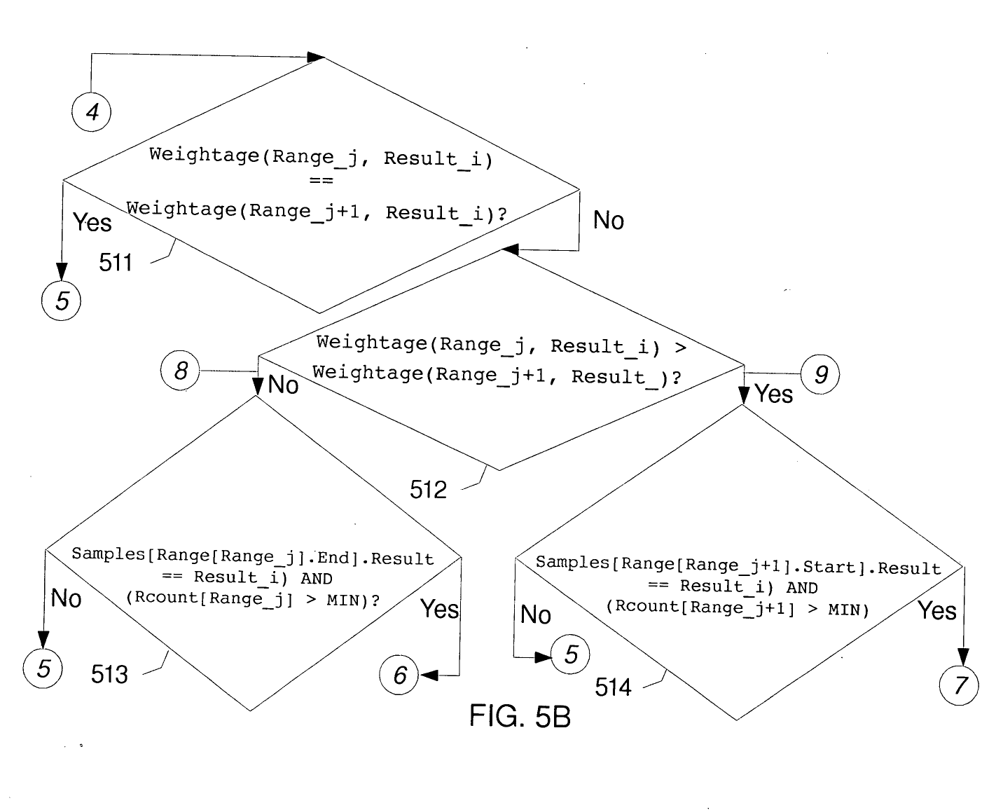

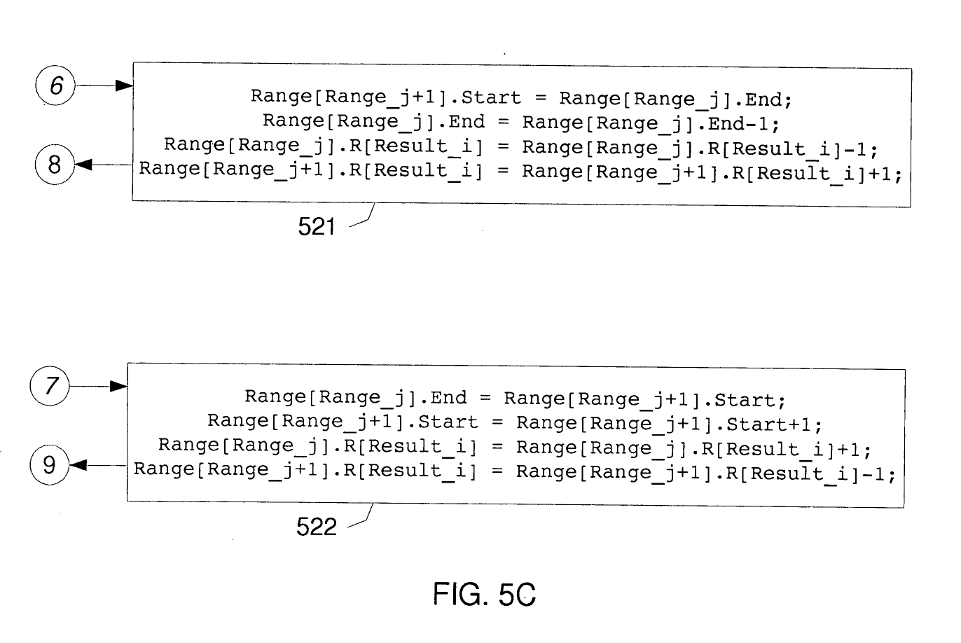

FIG. 5 illustrates an example of the state diagram of a function which is used for changing the start and end of ranges. The algorithm works with the datastructures illustrated in FIG. 4. The function has an outer loop in which a loop variable Result_i takes every values in the result value space. In this example, the variable Result_i can take values 1 to RMAX. Each Range has a first index corresponding to Start of the range and a second index corresponding to End of the range as illustrated in FIG. 4 and the array Samples (sample regions) which are sorted based on Values (parameter values) are indexed using Start and End indexes in the array Range. In the outer loop initialization state 501, the variable Result i is initialized to its first value 1. Before each iteration after the first iteration, the variable Result_i is incremented by 1 503. Inside the outer loop, the variable Result is tested 502 to check whether it exceeds RMAX wherein RMAX represents the highest value of result value space. If the value of the variable Result_i exceeds RMAX 504, the function returns. If Result_i is not greater than RMAX 505, the inner loop variable Range_j is initialized to 1. The inner loop is iterated for all ranges other than the last range. Before each iteration after the first iteration, the variable Range_j is incremented by 1 506. Inside the inner loop, the variable Range_j is tested 507 to check whether it exceeded RNGMAX−1 wherein RNGMAX represents index of the last range. If the value of the variable Range_i is greater than RNGMAX−1 507, the inner loop is exited and the next iteration of the outer loop begins with the next value of Result_i. Inside the inner loop 511 in FIG. 5B, the weightage of the result Result_i for the range Range_j is compared with the weightage of Result_i for the range Range_j+1. If the weightages are equal, the function goes to the state 506 in which the next iteration of the inner loop is started. If the weightages are not equal 512, the weightage of the result Result_i for Range_j is tested to check whether it is higher than the weightage of the result Result_i for the range Range+1. If the weightage of the result Result_i for the range Range_j is higher than the weightage of Result_i for Range_j+1, the function goes to the state 514 in which:
(a) the result of the first sample (sample region) at Start of the range Range_j+1 is compared for equality with the result Result_i;
(b) number of samples (sample regions) in the Range_j+1 is tested to check whether it is greater than minimum threshold MIN;
(c) and the results of that comparison and that test are AND operated.
   If the result of the AND operation 514 is true (the result of the first sample region at Start of the range Range_j+1 is same as the result Result_i and number of sample regions in the range Range_j+1 is greater than minimum threshold MIN) then the function goes to a state 522 in which the End of the range Range_j is made higher by:
(a) assigning Start of the range Range_j+1 to End of the range Range_j;
(b) incrementing Start of the range Range_j+1 by 1;
(c) incrementing the number of samples (sample regions) with Result_i for the range Range_j by 1; and
(d) decrementing the number of samples (sample regions) with Result_i for the range Range_j+1 by 1;
   and the AND operation 514 is repeated in a loop. If the result of AND operation 514 is false, the function goes to the state 506 in which the next iteration of the inner loop is started. If the weightage of the result Result_i for the range Range_j is less than the weightage of Result_i for Range_j+1 512, the function goes to the state 513 in which:
(a) the result of the last sample (sample region) at End of the range Range_j is compared for equality with the result Result_i;
(b) number of samples (sample regions) in the Range_j is tested to check whether it is greater than minimum threshold MIN;
(c) and the results of that comparison and that test are AND operated.
   If the result of the AND operation 513 is true (the result of the last sample (sample region) at End of the range Range_j is same as the result Result_i and number of samples (sample regions) in the range Range_j is greater than minimum threshold MIN) then the function goes to a state 521 in which the Start of the range Range_j+1 is made lower by:
(a) assigning End of the range Range_j to Start of the range Range_j+1;
(b) decrementing End of the range Range_j by 1;
(c) incrementing the number of samples (sample regions) with Result_i for the range Range_j+1 by 1;
(d) decrementing the number of samples (sample regions) with Result_i for the range Range_j by 1;
   and the AND operation 513 is repeated. If the result of AND operation 513 is false, the function goes to the state 506 in which the next iteration of the inner loop is started.

When we get a new digital image, parameter values corresponding to different regions and segments are computed. For each of such parameter values of a region or a segment, the range in which that parameter value falls in identified. The weightage of the range in which a parameter value falls is used to compute the expected result corresponding to that parameter. A function (example: sum) of weightages corresponding to all parameters for each result gives a total weightage for that result for a region or segment. The computer or embedded system chooses one or more results with the high total weightages and the corresponding total weightages to recommend the list of likely results.

When the number of sample regions within a range is below a threshold, a first or second or Nth complex weightage used instead of the simple weightage shown earlier. The first complex weightage is a function of simple weightage, the number of sample regions with a given result in the adjacent ranges of that given range, the number of sample regions in the adjacent ranges of that given range. The first complex weightage of region r, W2[r]=f2(X[r], T[r], X[r−1], T[r−1], X[r+1], T[r+1]) wherein X[r] is the number of sample regions with a known result A in that range; T[r] is the number of sample regions in that range; X[r−1] is the number of sample regions with a known result A in a first adjacent range; T[r−1] is the number of sample regions in that first adjacent range, X[r+1] is the number of sample regions with a known result A in a second adjacent range; and T[r+1] is the number of sample regions in that second adjacent range. An example of a formula for a first complex weightage is:

W[r]=(((2*X[r])−T[r])/T[r])+0.5*(((2*X[r−1])−T[r−1])/T[r−1])+0.5(((2*X[r+1])−T[r+1])/T[r+1]).

Similarly, a second complex weightage is also used to determine the weightage for the occurance of an event. For example, when sum of the number of sample regions in the range r, in the first adjacent range [r−1] and in the second adjacent range [r+1] is below a threshold, a second complex weightage is used. A second complex weightage of a given range is a function of the first complex weightage, number of sample regions with result A, X[r−2] and number of sample regions, T[r−2] for the range [r−2] which is an adjacent range of the range [r−1] and number of sample regions with result A, x[r+2] and number of sample regions, T[r+2] for the range [r+2] which is an adjacent range of the range [r+1] are used for computing.

An Nth complex weightage is a function of (N−1)th complex weightage,

When a new digital image of a human body part is to be analyzed for presence of cancer, parameters corresponding each segment or region of the digital image are computed. For each parameter of a segment or region, the range within which that extracted parameter value falls is identified. A result corresponding to the range and its weightage is calculated. A function of weightages for different parameters of a segment or a region is used to compute total weightage wherein the value of the total weightage indicates whether that segment or region of the digital image is likely to be cancerous. For example total weightage for the result R[1]:

$$\begin{matrix}Wt ( R [ 1 ] ) = fp ( W 1 ( R [ 1 ] ) , W 2 ( R [ 1 ] ) , … Wn ( R [ 1 ] ) \\ = W 1 ( R [ 1 ] ) + 0.5 * W 2 ( R [ 1 ] ) + W 3 ( R [ 1 ] )\end{matrix}$$

where W1, W2 and W3 are weightages for the ranges in which values of parameters 1, 2, 3 fall respectively, for the result R[1]. In this example, a high weightage indicates a higher probability that the region is cancerous. For example, for a state R[1] which corresponds to a cancerous state:
(1) Wt(R[1])>0.75 then there is high likelihood that a region is cancerous and a biopsy is required.
(2) 0.5<Wt(R[1])<0.75 then there is medium likelihood that a region is cancerous and a biopsy is recommended.
(3) 0.25<Wt(R[1])<0.5 then there is low likelihood that a region is cancerous and a repeat of investigation is recommended after month.
   It is possible to use a different weightage function such that a lower value indicates that the region is cancerous (for example negative of the function Wp[R1]).

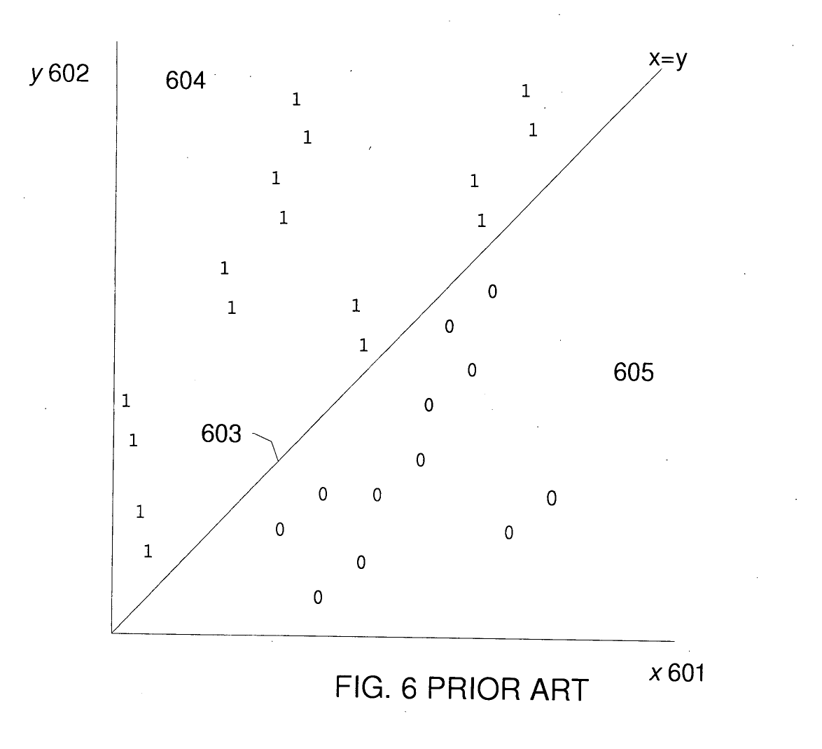

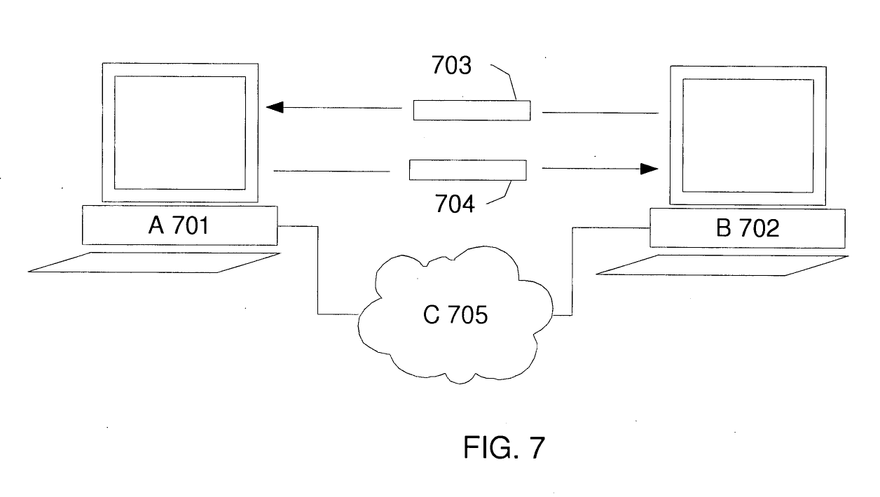

FIG. 6 illustrates the importance of combining properties of a region or a segment to arrive at parameters that provides a given result in a given range. All values 604 above or on the line 603 given by the function (y−x=0) are 1's and all values 605 below that line 603 are 0. Therefore if we plot results on a parameter y/x, range 0 to less than 1 will have the result 0 and the range 1 to infinity will have the result 1. If the state 1 corresponds to cancerous state, whenever we get a sample with parameter y/x>=1, it corresponds to a cancerous region. Similarly, whenever we get a sample with parameter y/x<1, it corresponds to a not cancerous region. However, if we use parameters x 601 or y 602, it is not possible to get good ranges or good results.

The function to be used to get good ranges are dependent of result distributions. The parameters to be used for each type of cancer and each type of digital image will differ. It is not the object of the invention to identify the parameters to be used for each type of cancer or digital image. However, parameters such as shape, size, intensity, color, statistical parameters such as mean, median, mode and standard deviation, distance between and relative positions of regions with colors or intensities corresponding to cancerous regions etc. are known to be good parameters and are used by the radiologists today for identifying cancer in images of human body or human body parts.

It is not possible for even an expert radiologist to find all useful ranges of parameters that can give a good result for analysis of cancer. For example, when there are ranges of values of intensities which indicates presense of cancer between ranges of values of intensities which does not indicate presense of cancer, humans are likely to miss ranges of intensities of interest due to the limitations of human visual systems. Similarly, even if parameters x and y are visible to human eye, humans cannot visually or accurately compute a parameter y/x which can be used for detection of cancer. Since a useful parameter can be a complex function of more than one visual characteristics of a region, visual identification of all parameters and all ranges of parameter values of interest is not possible. Therefore the region based technology proposed in this invention can make conclusive results with digital images more accurately than it is possible by humans. Nural networks emulates human brain and therefore has the same limitations as humans.

FIG. 7 illustrates an example of a computer used for providing cancer diagnostics over a network. The computer B 702 sends a digital image 703 of a human body part to a computer A 701 using a computer network C 705 connecting both the computer A and the computer B. A diagnostics algorithm implemented in the computer A 701 analyzes that digital image and creates a diagnostics. The computer A 701 sends that diagnostics 704 to the computer B 702 using a computer network C 705 connecting both the computer A and the computer B.

When computers which are used for dividing value space of a parameter into ranges wherein the range is used for diagnosis of cancer, are connected over a network, the efficiency of diagnosis can be improved by these computers by exchanging data such as results and parameters corresponding to each sample between each other. Efficient access to data corresponding to samples can be achieved by storing parameter values and result corresponding to each sample, ranges of parameters, count of sample regions in each range and count of sample regions in each range with each result in a database. A computer can get the diagnosis for cancer done on a digital image by sending that digital image to a computer which is used for diagnosis of cancer.

What is claimed is:

1. A method of dividing value space of a parameter into ranges wherein the said parameter is used to characterize a segment or a region of a digital image and the said ranges are used for assisting the investigation in detection of cancer in a human body part, the said method comprising:
(a) using sample regions wherein a sample region is a region or a segment in a digital image of human body or in a digital image of a part of a human body, with a known result wherein a known result identifies a region as cancerous, or healthy, or unhealthy but not cancerous, or affected by one or more illnesses affecting the human body, or affected by one or more cancers affecting the human body;
(b) using the values of the said parameter corresponding to the said sample regions; and
(c) dividing the value space of the said parameter into ranges using the said values of the said parameter corresponding to the said sample regions and the said known results.

2. A method of dividing value space of a parameter into ranges according to claim 1 wherein the said ranges are used for assisting the investigation in detection of cancer in a human body part, the said division of the value space of the said parameter into ranges is done such that the said ranges satisfy a set of conditions and/or thresholds.

3. A method of dividing value space of a parameter into ranges using sample regions according to claim 2 wherein the said ranges are used for assisting the investigation in detection of cancer in a human body part, further comprising adding one or more of the said sample regions into the said ranges wherein a sample region is added to a range in the value space of a parameter if the value of the said parameter corresponding to the said sample region is within the said range.

4. A method of dividing value space of a parameter into ranges based on conditions according to claim 3 wherein the said ranges are used for assisting the investigation in detection of cancer in a human body part, wherein at least one of the said conditions is that the number of the said sample regions in the same result ranges is maximized wherein a same result range is a range wherein all of the said sample regions in the said range have the same known result.

5. A method of dividing value space of a parameter into ranges based on thresholds according to claim 4 wherein the said ranges are used for assisting the investigation in detection of cancer in a human body part, wherein at least one of the said thresholds sets a lower limit for the number of sample regions in a same result range.

6. A method of dividing value space of a parameter into ranges based on conditions according to claim 4 wherein the said ranges are used for assisting the investigation in detection of cancer in a human body part, wherein at least one of the said conditions is that for a first range and a second range adjacent to each other in value space wherein the said first range has a higher weightage for a given result than the said second range, the said first range and the second range are changed so that the number of sample regions with the said result in the said first range is increased and number of sample regions with the said result in the said second range is accordingly decreased provided the said change can be done without affecting the number of sample regions with other results in the said first or the said second ranges, wherein weightage for a result in a range is a function of or ratio between the number of samples with the said result in the said range and number of samples in the said range.

7. A method of dividing value space of a parameter into ranges based on thresholds according to claim 6 wherein the said ranges are used for assisting the investigation in detection of cancer in a human body part, wherein at least one of the said threshold sets an upper limit for the number of sample regions in a range.

8. A method of dividing value space of a set of parameters into ranges based on thresholds according to claim 3 wherein the said ranges are used for assisting the investigation in detection of cancer in a human body part, wherein at least one of the said threshold sets a lower limit for the number of sample regions in a range.

9. A method of dividing value space of a parameter into ranges based on conditions according to claim 8 wherein the said ranges are used for assisting the investigation in detection of cancer in a human body part, wherein at least one of the said conditions is that the number of the said sample regions in the same result ranges is maximized wherein a same result range is a range wherein all of the said sample regions in the said range have the same known result.

10. A method of dividing value space of a parameter into ranges based on conditions according to claim 9 wherein the said ranges are used for assisting the investigation in detection of cancer in a human body part, wherein at least one of the said conditions is that for a first range and a second range adjacent to each other in value space wherein the said first range has a higher weightage for a given result than the said second range, the said first range and the second range are changed so that the number of sample regions with the said result in the said first range is increased and number of sample regions with the said result in the said second range is accordingly decreased provide the said change can be done without affecting the number of sample regions with other results in the said first or the said second ranges, wherein weightage for a result in a range is a function of or ratio between the number of samples with the said result in the said range and number of samples in the said range.

11. A method of dividing value space of a parameter into ranges according to claim 1 wherein the said ranges are used for assisting the investigation in detection of cancer in a human body part, wherein the said parameter is or is a first function of one or more of:
(i) a second function of one or more of shape or size or length or width or perimeter or color or intensity or histogram diagram of colors or histogram diagram of intensities or one or more of the statistical parameters such as mean, median, mode or standard deviation of the segments or regions of a digital image of a human body or part of a human body; and/or
(ii) relative changes compared to an older digital image of the same body part of the same human; and/or
(iii) number of and distance between regions of a range of colors or intensities corresponding to cancerous regions.

12. A method for assisting the investigation in detection of cancer in a region in a first digital image of a human body or a human body part which is being investigated for presence of cancer, the said method comprising:
(a) using a set of parameters which can be used to characterize a region of a digital image;
(b) using sample regions wherein a sample region is a region or segment of a second digital image of human body or a digital image of a part of a human body, with a known result wherein a known result identifies a region or segment as cancerous, or healthy, or unhealthy but not cancerous, or affected by one or more illnesses affecting the said region of the human body, or affected by one or more cancers affecting the said region of the human body;
(c) dividing the value space of one or more parameters in the said set of parameters into ranges wherein the said division of a parameter into ranges is done by using the values of that said parameter and the said known results corresponding to the said sample regions;
(d) using values of the parameters in a said set of the parameters, corresponding to the said region in the said first digital image of a human body part or human body which is being investigated for presence of cancer;
(e) for the said value of each parameter in a said set of the parameters corresponding to the said region in the said first digital image, identifying the said range of values of the said parameter within which said value of that said parameter falls; and
(f) using one of more said identified ranges of parameter values for assisting the investigation in detection of cancer.

13. A method for assisting the investigation in detection of cancer in a region in a first digital image of a human body part or human body which is being investigated for presence of cancer according to claim 12 wherein the said usage of one or more of the said identified ranges of values of the said parameters further comprising: for each range of a parameter in the said identified ranges, using a first count of sample regions in a first set of sample regions wherein the values of the said parameter for the sample regions in the said first set of sample regions, fall into the said range and a second count of sample regions in a second set of sample regions having a subset of known results wherein the values of the said parameter for the sample regions in the said second set of the sample regions, fall into the said range.

14. A method for assisting the investigation in detection of cancer in a region in a first digital image of a human body part or human body which is being investigated for presence of cancer according to claim 13 by dividing the value space of one or more of the said parameters into ranges wherein the said division of the value space of the said parameter into ranges is done such that the said ranges satisfy a set of conditions and/or thresholds.

15. A method for assisting the investigation in detection of cancer in a region in a first digital image of a human body part or human body being investigated for presence of cancer according to claim 14 wherein each of the said parameters is or is a function of one or more of size or shape or color or intensity or histogram diagram of color or histogram diagram of intensity or one of the statistical parameters such as mean, median, mode or standard deviation of the segments or regions of a digital image of a human body or part of a human body.

16. A method for assisting the investigation in detection of cancer in a region in a first digital image of a human body part or human body being investigated for presence of cancer according to claim 15 further comprising using one or more adjacent ranges of the said identified ranges of values of the said parameters wherein a first range is adjacent to a second range of values if the said ranges are adjacent to each other in the real number value space.

17. A method for assisting the investigation in detection of cancer in a region in a first digital image of a human body part which is being investigated for presence of cancer according to claim 16, using one or more adjacent ranges of the said identified ranges of values of the said parameters wherein the said usage of one or more of the said adjacent ranges of values of the said parameters further comprising for each range in the said adjacent ranges, using a third count of sample regions in a third set of sample regions wherein the values of the said parameter for the sample regions in the said third set of sample regions, fall into the said adjacent range and a forth count of sample regions in a forth set of sample regions having a subset of known results wherein the values of the said parameter for the sample regions in the said forth set of the sample regions, fall into the said adjacent range.

18. A method for assisting the investigation in detection of cancer in a region in a first digital image of a human body part which is being investigated for presence of cancer according to claim 17, further comprising adding one or more of the said sample regions into the said ranges wherein a sample region is added to a range in the value space of a parameter if the value of the said parameter corresponding to the said sample region is within the said range.

19. A method for assisting the investigation in detection of cancer in a region in a first digital image of a human body part or human body which is being investigated for presence of cancer according to claim 14 by dividing the value space of one or more of the said parameters into ranges based on conditions wherein at least one of the said conditions is that the number of the said sample regions in the same result ranges is maximized wherein a same result range is a range wherein all of the said sample regions in the said range have the same known result.

20. A method for assisting the investigation in detection of cancer in a region in a first digital image of a human body part or human body which is being investigated for presence of cancer according to claim 19 by dividing the value space of one or more of the said parameters into ranges based on conditions wherein at least one of the said conditions is that for a first range and a second range adjacent to each other in value space wherein the said first range has a higher weightage for a given result than the said second range, the said first range and the second range are changed so that the number of sample regions with the said result in the said first range is increased and number of sample regions with the said result in the said second range is accordingly decreased if the said change can be done without affecting the number of sample regions with other results in the said first or the said second ranges, wherein weightage for a result in a range is a function of or ratio between the number of samples with the said result in the said range and number of samples in the said range.

21. A method for assisting the investigation in detection of cancer in a region in a first digital image of a human body part being investigated for presence of cancer according to claim 14 using a database wherein the parameter values and result corresponding to the said sample regions, the said ranges of values of parameters, the said first count and the said second count are added to the said database.

22. Two or more computers used for dividing value space of a set of parameters into ranges wherein the said ranges of values of parameters are used for detection of cancer in a region in a digital image of a human body part or human body being investigated for presence of cancer, the said computers communicating parameter values and result corresponding to each of the sample regions to each other computer wherein a sample region is a region or a segment of a second digital image of human body or a part of a human body, with a known result wherein a known result identifies a region as cancerous or healthy or unhealthy but not cancerous or affected by one or more illnesses affecting the said region of the human body or affected by one or more cancers affecting the said region of the human body.

23. Two or more computers used for dividing value space of a set of parameters into ranges according to claim 22 wherein the said ranges of values of parameters are used for detection of cancer in a region in a digital image of a human body part being investigated for presence of cancer, the said computers using a plurality of databases to store the said parameter values and the said known result corresponding to each of the said sample regions.

24. Two or more computers used for dividing value space of a set of parameters into ranges according to claim 22 wherein the said ranges of values of parameters are used for detection of cancer in a region in a digital image of a human body part being investigated for presence of cancer, the said division of the value space of a set of parameters is done using the parameter values and the said results corresponding to the said sample regions.

25. A method of a first computer receiving a digital image of a human body part or human body for cancer diagnosis from a second computer over a computer network and the said first computer sending a reply to the said second computer wherein the said reply contains the diagnostics for cancer done on the said digital image.
